(19) United States
(12) Patent Application Publication
(10) Pub. No.: US 2009/0291230 A1
(43) Pub. Date: Nov. 26, 2009

(54) INK AND METHOD OF FORMING ELECTRICAL TRACES USING THE SAME

(75) Inventors: CHENG-HSIEN LIN, Tayuan (TW); YAO-WEN BAI, Shenzhen (CN); RUI ZHANG, Shenzhen (CN)

Correspondence Address: PCE INDUSTRY, INC.;ATT. Steven Reiss, 288 SOUTH MAYO AVENUE, CITY OF INDUSTRY, CA, 91789, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 12/468,066

(22) Filed: May 19, 2009

(30) Foreign Application Priority Data
May 26, 2008 (CN) 200810301775.7

(51) Int. Cl. B05D 3/06; C09D 11/02; C08K 3/10

(52) U.S. Cl. 427/553; 106/31.13; 524/434

(57) ABSTRACT

A silver-containing ink includes an aqueous carrier medium having both a silver salt and an amine sensitizer for the silver salt dissolved therein, and a light sensitive reducing agent dispersed in the aqueous carrier medium. The amine sensitizer includes at one or more amine group; and the light sensitive reducing agent is capable of reducing the silver in the silver-containing ink to silver particles when irradiated.

### CROSS-REFERENCE TO RELATED APPLICATIONS

This application is related to the following commonly-assigned copending applications: application Ser. No. 12/235,994, entitled “METHOD OF FORMING CIRCUITS ON CIRCUIT BOARD;” application Ser. No. 12/253,869, entitled “PRINTED CIRCUIT BOARD AND METHOD FOR MANUFACTURING SAME;” and application Ser. No. 12/327,621, entitled “INK AND METHOD OF FORMING ELECTRICAL TRACES USING THE SAME.” The disclosures of the above-identified applications are incorporated herein by reference.

### BACKGROUND

1. Technical Field

The present disclosure relates generally to inks, and particularly, to a silver-containing ink for printing electrical traces on printed circuit boards.

2. Description of Related Art

Ink jet circuit printing is becoming more and more popular and attractive in the fabrication of printed circuit boards due to its high flexibility. In a typical ink jet circuit printing method, an ink containing a great number of micro metal particles is printed onto a specified area of a substrate using an ink jet printer to create a pattern of ink. A metal pattern comprised of metal particles is obtained after solvents in the pattern of ink are removed. However, the metal particles in the metal pattern have loose contact between each other, and accordingly, the metal pattern has poor electrical conductivity. A heating process (for example, sintering at 200 to 300 degrees Celsius (° C.)) is required to bond the metal particles together, thereby improving the electrical conductivity of the metal pattern. However, commonly used substrates for printed circuit boards are comprised of polymer such as polyimide, which has low heat resistance. Thus, even at 200 to 300° C., the substrate starts to soften and deform, and the quality of the substrate and the electrical traces may be compromised.

Therefore, there is a desire to overcome the aforementioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. In the drawings, all the views are schematic.

FIG. 1 is a flowchart of a method of forming electrical traces on a substrate in accordance with an exemplary embodiment.

FIG. 2 is a cross-sectional view of part of an exemplary substrate used in the method of FIG. 1.

FIG. 3 is similar to FIG. 2, but showing an ink pattern printed on a surface of the substrate.

FIG. 4 is similar to FIG. 3, but showing the ink pattern transformed into an underlayer.

FIG. 5 is similar to FIG. 4, but showing the structure after a metal overcoat layer has been plated on the underlayer thereby obtaining electrical traces.

### DETAILED DESCRIPTION OF EMBODIMENTS

In an exemplary embodiment, a silver-containing ink includes an aqueous carrier medium having both a silver salt and an amine sensitizer for the silver salt dissolved therein, and a light sensitive reducing agent dispersed in the aqueous carrier medium.

The aqueous carrier medium can be water, or a mixture of water and at least one water soluble organic solvent. The at least one water soluble organic solvent can be selected from, for example, alcohols such as methyl alcohol, ethyl alcohol, n-propyl alcohol, iso-propyl alcohol, n-butyl alcohol, sec-butyl alcohol, t-butyl alcohol, iso-butyl alcohol, furfuryl alcohol, and tetrahydrofurfuryl alcohol, ketones or ketoalcohols such as acetone, methyl ethyl ketone and diacetone alcohol, ethers such as tetrahydrofuran and dioxane, esters such as ethyl lactate, polyhydric alcohols such as ethylene glycol, diethylene glycol, triethylene glycol, propylene glycol, tetraethylene glycol, polyethylene glycol, glycerol, 2-methyl-2,4-pentanediol 1,2,6-hexanetriol and thiodiglycol, lower alkyl mono- or di-ethers derived from alkylene glycols, such as ethylene glycol mono-methyl (or -ethyl)ether, diethylene glycol mono-methyl (or -ethyl)ether, propylene glycol mono-methyl (or -ethyl)ether, triethylene glycol mono-methyl (or -ethyl)ether and diethylene glycol di-methyl (or -ethyl)ether, nitrogen containing cyclic compounds such as pyrrolidone, N-methyl-2-pyrrolidone, and 1,3-dimethyl-2-imidazolidinone, and sulfur-containing compounds such as dimethyl sulfoxide and tetramethylene sulfone. The silver salt is selected from the group consisting of silver nitrate, silver nitrite, silver carbonate, silver sulfate, silver phosphate, silver chlorate, silver perchlorate, silver fluoride, silver chloride, silver iodide, silver tetrafluoroborate, silver acetate, silver trifluoroacetate, silver pentafluoropropionate, silver lactate, silver citrate, silver oxalate, silver tosylate, silver methanesulfonate, and silver triflate. A concentration of the silver salt in the ink is in the range from approximately 10⁻⁴ mol/L to approximately 5 mol/L. In certain preferred embodiments, the concentration of the silver salt in the ink is in the range from approximately 0.1 mol/L to approximately 1 mol L.

The amine sensitizer can be an organic nitrogen-based compound such as primary, secondary and tertiary aliphatic and aromatic amines, or nitrogen heterocycles such as pyridine and bipyridine. Said amines can be monofunctional amines and/or multifunctional amines such as diamines, triamines, tetramines and so on. In other words, the amine sensitizer includes one or more amine group. A molar ratio of the amine sensitizer to the silver salt is in the range from 1:1 to 3:1. That is, a concentration of the amine sensitizer in the ink is in the range from approximately 10⁻⁴ mol/L to approximately 15 mol/L. In certain preferred embodiments, the concentration of the amine sensitizer in the ink is in the range from approximately 0.1 mol/L to approximately 3 mol/L.

The light sensitive reducing agent can be sodium citrate or potassium sodium tartrate, each of which has a concentration in the ink in the range from approximately 10⁻⁷ to approximately 5 mol/L. In other embodiments, a molar ratio of the light sensitive reducing agent to the silver salt is in the range from 1:10 to 1:200. In still other embodiments, the concentration of the light sensitive reducing agent in the ink is in a range from approximately 10⁻⁴ mol/L to approximately 0.5 mol/L.

It is understood that the compositions and concentrations of the silver salt, the amine sensitizer, and the light sensitive reducing agent may be chosen according to practical needs, and are not limited to those described herein.

Additionally, to improve the bonding force between the ink and a surface of the substrate, a surfactant, a viscosity modifier, a binder material (or “binder”), a humectant, or any mixture thereof, can be selectively added into the silver-containing ink to adjust viscosity, surface tension, and/or stability of the ink. The surfactant can be anionic, cationic or non-ionic. The binder can be polyurethane, polyvinyl alcohol or any suitable water-soluble macromolecular polymer.

In the present embodiment, the aqueous carrier medium comprises ethylene glycol at approximately 50% or less by weight. The percentage of the binder is in the range from 0.1% to 20% by weight, the percentage of the viscosity modifier is in the range from 0.1% to 50% by weight, and the percentage of the surfactant is the range from 0.1% to 5% by weight. These percentages are based on the total weight of the silver-containing ink.

When the ink is irradiated at a predetermined wavelength, an oxidation-reduction reaction between the light sensitive reducing agent and the silver salt occurs, and the silver salt is reduced to silver metal particles. The irradiation can be any suitable form of high energy radiation, such as ultraviolet light from an ultraviolet laser, or gamma (γ) radiation. It is known that an oxidizability of the silver salt in the ink is relatively weak. To activate and maintain the oxidation-reduction reaction between the light sensitive reducing agent and the silver salt, as the reducibility of the light sensitive reducing agent decreases, the energy of the irradiation must be increased. In other words, irradiation having a lower wavelength is required. In addition, the reaction rate of the oxidation-reduction reaction is proportionate to the energy density of the irradiation (i.e., the amount of irradiation). That is, to maintain a high reaction rate of the oxidation-reduction reaction, the energy density of the irradiation must be set at a high level.

A reaction rate of the oxidation-reduction reaction is in direct proportion to the reducibility of the reducing agent. Thus, ink with a weaker reducing agent has a longer shelf lifetime, and ink with a stronger reducing agent has a higher reaction rate. To avoid deterioration of the ink prior to its use, it is best to preserve the ink in dark surroundings.

Compared with nanoscale metal particles, the silver in the ink exhibits excellent dispersion. That is, aggregation of the silver in the ink can be efficiently prevented. In particular, because the silver ions are uniformly dissolved, electrical traces of uniform thickness and width can be achieved. In addition, the silver salt and the light sensitive reducing agent coexist in the ink, and thus the silver salt and the light sensitive reducing agent are simultaneously applied onto a surface of a substrate using a single apparatus and process.

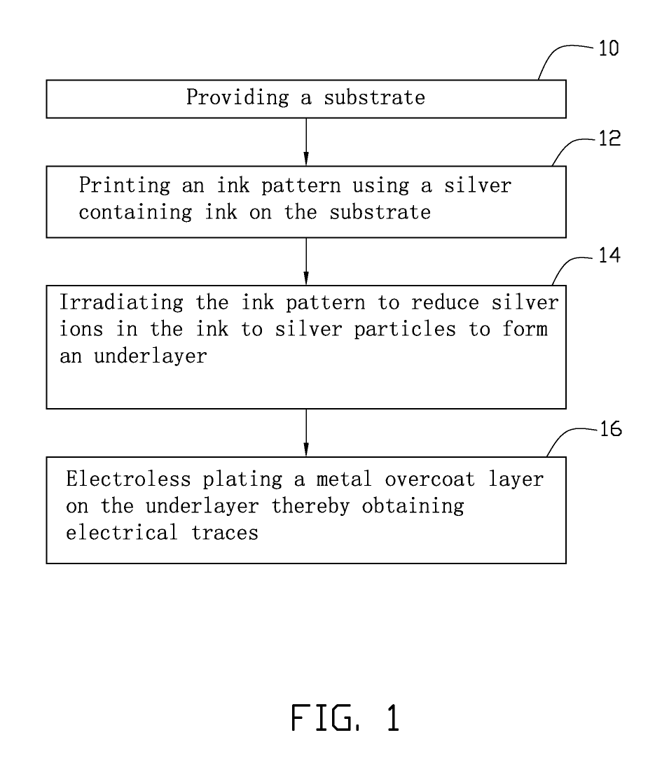

Referring to FIG. 1, an exemplary embodiment of a method of forming electrical traces on a substrate using the ink is summarized.

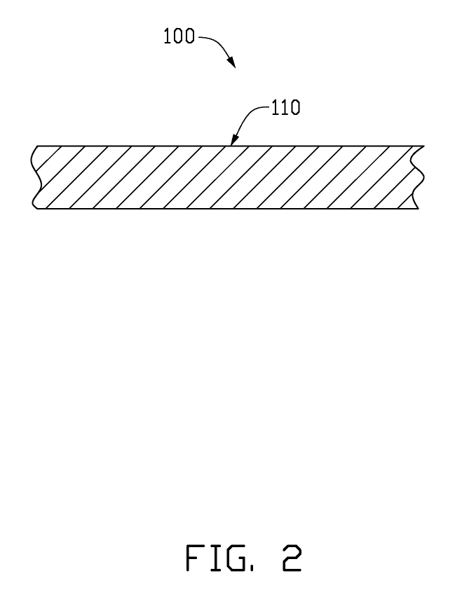

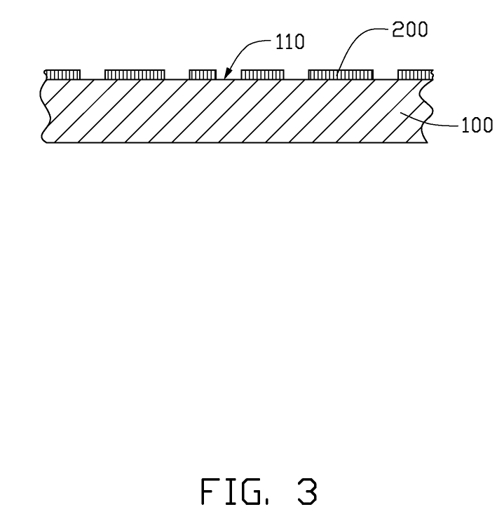

In step 10, referring to FIG. 2, a substrate 100 is provided. The substrate 100 is made of material suitable for hosting printed circuitry, such as polyimide (PI), poly(ethylene napthalate) (PET), polyarylene ether nitrile (PEN), and so on. The substrate 100 has a surface 110. To improve bonding force between an ink pattern 200 (see FIG. 3) and the surface 110, the surface 110 can be cleaned or micro-etched to remove pollutants, oil, grease and other contaminants therefrom.

In step 12, referring to FIG. 3, an ink pattern 200 comprised of the silver containing ink is printed on the surface 110 of the substrate 100 using an ink jet printer. For example, an Epson™ R230 ink jet printer equipped with a special disc tray can be used. Limited by the Epson™ R230 ink jet printer, the minimum line width of the ink pattern 200 is 0.1 mm. However, it is understood that the minimum line width can be further decreased by employing high resolution printers. As the silver salts are uniformly dissolved in the silver-containing ink, the silver salts are also uniformly distributed in the ink pattern 200.

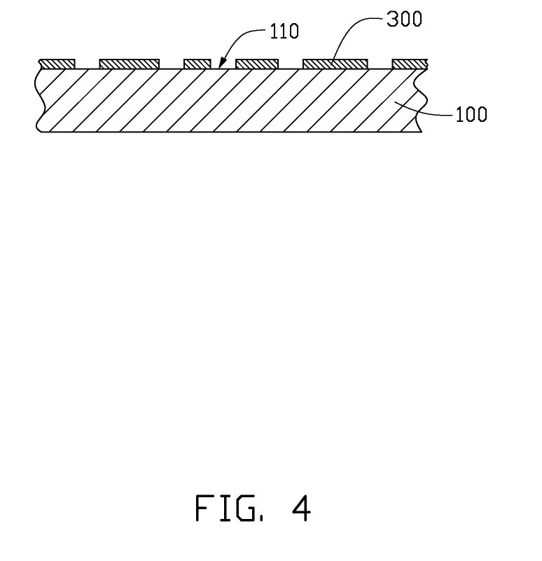

In step 14, referring to FIG. 4, the ink pattern 200 is irradiated to reduce the silver salts therein to silver particles, thereby forming an underlayer 300 comprised of a plurality (i.e., multiplicity) of silver particles. The irradiation can be by any suitable form of high energy radiation, such as ultraviolet laser light or γ radiation. The irradiation generally lasts from approximately 1 minute to 12 minutes, thereby achieving a substantially short manufacturing cycle for the underlayer 300. The type of irradiation and the period of irradiation can be varied according to the light sensitive reducing agent employed.

In the present embodiment, the silver containing ink used to form the ink pattern 200 includes silver chloride and sodium citrate with weak reducibility. High energy ultraviolet irradiation is applied to the ink pattern 200, and the irradiation reduces the silver ions of the silver chloride to silver particles. The substrate 100 with the ink pattern 200 thereon is dried at approximately 65° C. The drying effectively evaporates other liquid solvents of the ink (e.g., the aqueous carrier medium), with only the solid silver particles remaining to form the underlayer 300. Average particle size as measured by a scanning electron microscope (SEM) is approximately 60 to 300 nm (nanometers). The nanoscale silver particles are distributed on the surface 110 regularly and evenly, whereby the underlayer 300 correspondingly has a uniform width and thickness. In other embodiments, the average particle size of the silver particles can be of any suitable scale, such as nanoscale (e.g., 1 nm to 999 nm) or microscale (e.g., 1 micrometer to 100 micrometers).

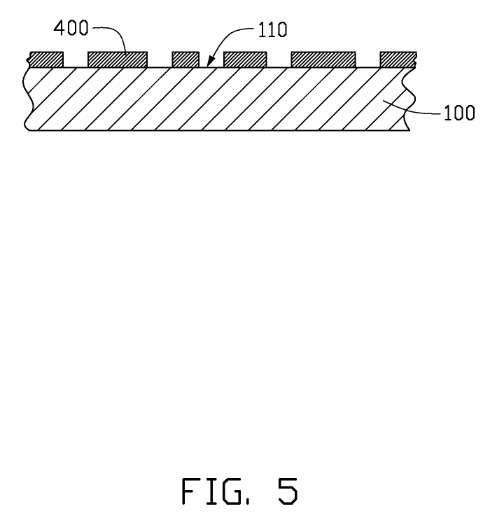

In step 16, a metal overcoat layer is plated on the underlayer 300 using electroless plating, thereby forming a number of electrical traces 400, as shown in FIG. 5. Generally, the underlayer 300 comprised of a number of silver particles has low electrical conductivity due to its incompact structure. Thus, the metal overcoat layer plated on the underlayer 300 yields the electrical traces 400 which have improved electrical conductivity.

In the plating process, each of the silver particles in the underlayer 300 is a reaction center, and the metal encapsulates each of the silver particles. Spaces (interstices) between adjacent silver particles are entirely filled with the metal. Thereby, the silver particles of the underlayer 300 are electrically connected by the metal, thus providing the electrical traces 400 with good electrical conductivity.

In the present embodiment, the metal overcoat layer is copper. In detail, the underlayer 300 is dipped into an electroless plating solution comprising a plurality of copper ions at 50° C. for 2 minutes. Copper particles are deposited in the spaces between adjacent silver particles, thereby forming the electrical traces 400 in which the silver particles are electrically connected to the copper particles. Average particle size of the copper particles is from approximately 50 nm to approximately 150 nm. Typically, the copper particles also form a continuous overlayer of copper on the silver particles, such that the electrical traces 400 have smooth top copper surfaces.

Moreover, the electroless plating solution may further include other materials, such as a copper compound, a reducing agent, and a complexing agent. The copper compound may be selected from copper sulfate, copper chloride, and other suitable copper ion-containing compounds. The light sensitive reducing agent may be methanol or glyoxylic acid. The complexing agent may be potassium sodium tartrate or ethylene diamine tetraacetic acid disodium salt. The electroless plating solution can also include a stabilizing agent, a surfactant, and a brightening agent therein in order to meet practical electroless plating requirements. In the present embodiment, the electroless plating solution includes 10 g/L of copper sulfate, 22 g/L of potassium sodium tartrate, 50 g/L of ethylene diamine tetraacetic acid disodium salt, 15 mL/L of formaldehyde, and 10 mL/L of methanol. The term “g/L” is used herein to refer to a mass amount of a solute (i.e., the copper sulfate, the potassium sodium tartrate and the ethylene diamine tetraacetic acid disodium salt) based on a total volume of the electroless plating solution. Similarly, the term “mL/L” is applied herein to refer to a volume amount of a solvent (i.e., the formaldehyde and the methanol) based on a total volume of the electroless plating solution.

It is known that a reaction rate of silver ions with sodium citrate is in direct proportion to the concentration of sodium citrate; thus, the more sodium citrate, the more silver ions are reduced to silver particles. In the plating process, the silver particles act as reaction centers for depositing copper particles. Hence, the particle size of the copper particles is reduced when there are more silver particles. As a result, the formed electrical traces 400 can achieve a higher distribution density of the copper and silver particles therein. Accordingly, the electro-conductivity of the electrical traces 400 is improved.

It is also known that the reaction rate of silver ions with sodium citrate is maximized at a specific concentration of sodium citrate (e.g. a molar ratio of 80:1 of the sodium citrate to the silver salt). If the concentration of sodium citrate is greater than the optimum concentration, remaining amounts of sodium citrate are liable to encapsulate the silver particles but not react with the silver particles. In such case, the number of reaction centers for the electroless plating process is reduced.

In contrast, when the ratio of sodium citrate to silver salt is lower than 20:1, thin and discontinuous electrical traces 400 are formed on the surface 110 due to the low concentration of silver ions in proportion to the total amount of sodium. Therefore the copper particles plated on the silver particles are relatively small in scale and quantity, and tend to fail to properly interconnect adjacent silver particles in the electroless plating process. Correspondingly, the electrical traces 400 are incapable of achieving high electrical conductivity.

The reaction time of the silver ions with the sodium citrate is in direct proportion to the period of irradiation with ultraviolet light. Thus, the longer the period of irradiation, the more silver ions are reduced by the sodium citrate to form silver particles with smaller particle size. In addition, a properly chosen ink composition and irradiation parameters are helpful in, for instance, efficiently forming the silver particles of the underlayer 300 and thereby forming continuous and highly electro-conductive electrical traces 400.

The surface 110 of the substrate 100 with the electrical traces 400 formed thereon is applied in the manufacture of electrical devices such as printed circuit boards and semiconductor application devices. The above-described method provides a combination of chemical reaction and plating methods, rather than high temperature sintering, to interconnect nanoscale metal particles. Thus, the method provides the electrical traces 400 with improved continuity and electro-conductivity, and avoids the difficulties of temperature control associated with conventional sintering processes.

While certain embodiments have been described and exemplified above, various other embodiments from the foregoing disclosure will be apparent to those skilled in the art. The present invention is not limited to the particular embodiments described and exemplified, but is capable of considerable variation and modification without departure from the scope and spirit of the appended claims.

What is claimed is:

1. A silver-containing ink, comprising:
an aqueous carrier medium having dissolved therein a silver salt and an amine sensitizer for the silver salt, the amine sensitizer comprising at least one amine group; and
a light sensitive reducing agent capable of reducing the silver in the aqueous carrier medium to silver particles dispersed in the aqueous carrier medium when irradiated.

2. The silver-containing ink of claim 1, wherein the light sensitive reducing agent is selected from the group consisting of sodium citrate and potassium sodium tartrate.

3. The silver-containing ink of claim 1, wherein a concentration of the light sensitive reducing agent in the ink is from approximately 10⁻⁷ mol/L to approximately 5 mol/L.

4. The silver-containing ink of claim 1, wherein the concentration of light sensitive reducing agent in the ink is from approximately 10⁻⁴ mol/L to approximately 0.5 mol/L.

5. The silver-containing ink of claim 1, wherein a concentration of the amine sensitizer in the ink is from approximately 10⁻⁴ mol/L to approximately 15 mol/L.

6. The silver-containing ink of claim 1, wherein a concentration of the amine sensitizer in the ink is from approximately 10⁻¹ mol/L to approximately 3 mol/L.

7. The silver-containing ink of claim 1, wherein a concentration of the silver salt in the ink is in the range from approximately 10⁻⁴ mol/L to approximately 5 mol/L.

8. The silver-containing ink of claim 1, wherein a concentration of the silver salt in the ink is in the range from approximately 0.1 mol/L to approximately 1 mol/L.

9. The silver-containing ink of claim 1, wherein a molar ratio of the amine sensitizer to the silver salt is in the range from approximately 1:1 to approximately 3:1.

10. The silver-containing ink of claim 1, wherein a molar ratio of the light sensitive reducing agent to the silver salt is in the range from approximately 1:10 to approximately 1:200.

11. The silver-containing ink of claim 1, further comprising at least one item selected from the group consisting of a binder, a viscosity modifier, a humectant, and a surfactant.

12. The silver-containing ink of claim 11, wherein the binder is one of polyurethane and polyvinyl alcohol, the viscosity modifier is polyvinyl pyrrolidone, and the humectant is selected from the group consisting of glycol, glycol ether, diethylene glycol, and glycerol.

13. The silver-containing ink of claim 11, wherein a volume ratio of each of the binder, the viscosity modifier, the humectant, and the surfactant in the ink is in the range from approximately 0.1% to approximately 50%.

14. A method for forming electrical traces, the method comprising:
providing a substrate;
printing an ink pattern on the substrate using a silver containing ink, the ink comprising:
an aqueous carrier medium having dissolved therein a silver salt and an amine sensitizer for the silver salt, the amine sensitizer comprising at least one amine group; and
a light sensitive reducing agent capable of reducing the silver in the aqueous carrier medium to silver particles dispersed in the aqueous carrier medium when irradiated;
irradiating the ink pattern to reduce silver ions in the ink to silver particles thereby forming a underlayer on the substrate; and
electroless plating a metal overcoat layer on the underlayer thereby obtaining electrical traces.

15. The method of claim 14, wherein the metal overcoat layer is a copper overcoat layer.

16. The method of claim 14, wherein an electroless plating solution used in the electroless plating comprises at least one item selected from the group consisting of copper sulfate, potassium sodium tartrate, ethylene diamine tetraacetic acid disodium salt, formaldehyde, and methanol.

17. The method of claim 14, wherein the irradiating is with ultraviolet radiation.

18. The method of claim 14, wherein the ink pattern is irradiated for a period in the range from approximately 1 minute to approximately 20 minutes.
